(19) United States
(12) Patent Application Publication
(10) Pub. No.: US 2002/0083008 A1
(43) Pub. Date: Jun. 27, 2002

(54) Method and system for identity verification for e-transactions

(76) Inventors: Christopher F. Smith, Holliston, MA (US); Albert L. Bessey, Holliston, MA (US); Steven E. Brenner, Framingham, MA (US); Dan Murray, Dorchester, MA (US); Richard A. Stewart, Union, KY (US); Victor Beck, Sudbury, MA (US); Robert J. Mossi, Medford, MA (US); Ron Kopolovic, Brookline, MA (US); Brian C. Bartlett, North Attleboro, MA (US)

Correspondence Address: PERKINS, SMITH & COHEN LLP, ONE BEACON STREET, 30TH FLOOR, BOSTON, MA, 02108, US

(21) Appl. No.: 09/747,746

(22) Filed: Dec. 22, 2000

(51) Int. Cl. G06F 17/60

(52) U.S. Cl. 705/64

(57) ABSTRACT

A user of a verification system registers directly at the verification system web site or by proxy at the time of engaging in an e-transaction through a vendor's web site. Upon registration, the user provides personal information in a secure environment. The verification system checks the database to cross-reference the user-provided information with the government-certified, or non-government certified data stored in the verification system databases. The verification system then creates a unique identifier and a digital identification badge. The user inputs the unique identifier into the system at the start of an e-transaction and the digital identification badge is securely transmitted from the verification system to the vendor in response to the unique identifier. The vendor decrypts the digital identification badge to confirm that the user is authorized to make a particular e-transaction.

### CROSS-REFERENCE TO RELATED APPLICATIONS

This application claims priority of U.S. provisional applications Ser. No. 60/173,258 entitled, “Method and System for Identity and Age Verification for E-Commerce” filed Dec. 23, 1999 by the present applicants.

### FIELD OF THE INVENTION

This invention relates generally to electronic transactions (e.g. e-commerce, e-prescriptions, e-government, etc.) and more particularly to Internet transactions requiring identity verification.

### BACKGROUND OF THE INVENTION

The Internet has expanded transactions well beyond the face-to-face transactions in traditional store-type settings and also beyond mail-order commerce. Goods of all kinds are available to anyone with a credit card number. Many businesses are conducting commerce over the Internet to sell products/services where anonymity is the norm and these businesses do not have the means to verify individuals associated with purchases. Additionally, many businesses that traditionally have been required by federal and state government regulations to verify age of buyers of “age-sensitive”products are now conducting commerce over the Internet. Age-sensitive products include, but are not limited to, alcoholic beverages, tobacco products, and adult entertainment products. For e-prescriptions, an example is the need to verify a state licensed doctor's identity for generating a new on-line prescription at a patient's local pharmacy. For e-government, an example is the need to verify a registered voter's identity for on-line voting.

The accessibility and ease of manipulating on-line transactions has provided a foundation from which identity theft and fraudulent purchases can flourish. On-line merchants are responsible for these transactions since on-line transactions lack a customer signature. Fraudulent transactions can cost many Internet retailers billions in lost revenues. Also, the ease of use of the Internet has lured many underage customers to the on-line alcohol, tobacco and adult entertainment web sites. Many sites are struggling to keep the under-aged away but have not found an effective way to verify on-line identities (of which age is a component). The possible development of other forms of electronic payment, e.g., e-dollars, will ease the buyer's ability to buy, but not necessarily ease the seller's ability to verify the identity of the buyer.

Existing identity verification methods include the use of credit cards. The ready availability of credit cards even to minors gives rise to the problem of age verification in the purchase of age-restricted merchandise. This is further complicated by the issue of stolen credit card information, which gives rise to an additional need for identity verification. In sum, possession of a credit card does not automatically assure that the holder is of adult age legally eligible to obtain various age-sensitive products and services.

Another current method of identity verification is through the use of faxed information (e.g., a driver's license). It is, however, difficult to decipher graphics in a faxed copy to distinguish a genuine legal ID from a counterfeit, and information is easily altered with standard desktop publishing programs.

A third current method of identity verification is in-person verification upon delivery of a product. This method works only for products that are delivered to a physical address by a person. This method, however, requires that delivery personnel be experts in license verification and currently they are not, nor are they likely to be in the future. Further, shipping companies are reluctant to store undeliverable packages, and the vendor pays shipping if the customer is ultimately denied the shipment and the package is returned. It is important to note that not all identity-sensitive products available on the Internet are of the type that requires delivery to a physical address.

Another current method of identity verification is the honor system. Customers can easily, and generally without negative consequences, ignore this method.

It remains desirable to have an effective method of identity verification in the process of authorizing the purchase of products/services and age-restricted products over the Internet to prevent the further proliferation of identity fraud.

It is an object of the present invention to provide a method and apparatus to provide private and secure identity verification for the authorization of e-transactions.

### SUMMARY OF THE INVENTION

The problems of verifying identity of an individual user buying products or using services over the Internet are solved by the present invention of a secure verification system using certified data and a method of transferring the information to the vendor (e.g. PKI, SSL, secure wireless protocol, or other analog or digital transmission).

In the present invention, certified data is defined in one of the following ways:

1. any certified data supplied to a party by one or more third parties trusted to create or keep accurate records of such information, (e.g., government, bank, insurance, or notary) exemplified by driver's license data (Department of Motor Vehicles or “DMV” data).

2. any certified data created by a party considered to be a trusted authority of identity (e.g. a bank).

3. Any combination of certified data as specified above. This certified data is cross-referenced with a user's personal data, such as name, shipping address, Social Security Number, or other data publicly or privately known to the individual in order to make a digital identification badge and a unique identifier. The digital identification badge is an encrypted container of the certified personal information necessary to complete electronic transactions, also called “e-transactions”. The unique identifier is used to transfer the digital identification badge (i.e. ID badge), with the user's specific actions and consent, to the provider over a communications medium such as the Internet. The ID badge (containing, for example, name, address and age) is considered “incorruptible” because it is transmitted directly from the verification system's site to the vendor site in encrypted form using, for example, Public Key Infrastructure (PKI), Secure Sockets Layer (SSL) encryption, cryptocards (i.e. smartcards), or other secure medium so that any alteration would be detected.

A user wanting to obtain an ID badge may register directly at the verification system site, by proxy through an on-line provider at the time of purchasing an item through the provider's site, or by any non-Internet means (e.g. by telephone, in person at a physical establishment). The verification system has a verification database created of certified data, for example, from driver's license data of the several states (and the District of Columbia) or records from banks, insurance companies or other trusted third parties. The sources of certified data can be combined and cross-referenced in order to create a more thorough database of certified data. During registration with the verification system, the user provides personal information, to establish identity. The verification system checks the verification database to cross-reference the user-provided information with the certified data in the verification database. The verification system then creates a unique identifier (e.g. a Personal Identification Number (PIN)) for the user, and creates digital identification badge (ID Badge) that contains the user's information necessary to complete an electronic transaction (e.g. digital signature, name, address, and, age), and stores the user's unique identifier and ID badge in the ID badge verification database. When the user wants to initiate a transaction with an on-line provider, the user provides his or her unique identifier to the provider using a data packet, stream, digital certificate, or other method of transfer. The provider then similarly transmits this data to the verification system at the time of a transaction, which the verification system then uses to confirm that the user user's identity. Upon successful user identification verification, the verification system transfers the user's ID badge to the provider as proof of authorization to complete the user's requested transaction. If the user is not successfully verified, the provider is notified of the unauthorized status of the user, allowing the provider to make a decision as to whether or not the transaction requested by the user is to be completed.

The present invention together with the above and other advantages may best be understood from the following detailed description of the embodiments of the invention illustrated in the drawings, wherein:

### BRIEF DESCRIPTION OF THE DRAWINGS

FIG. 1 is a part-schematic/part-flow diagram of a user identity verification and authorization system according to principles of the invention;

FIG. 2 is a block diagram of the verification system of FIG. 1; and

FIG. 3 is a detailed part-schematic block diagram/part-flow chart of the verification and authorization process according to principles of the invention.

### DETAILED DESCRIPTION OF PREFERRED EMBODIMENTS

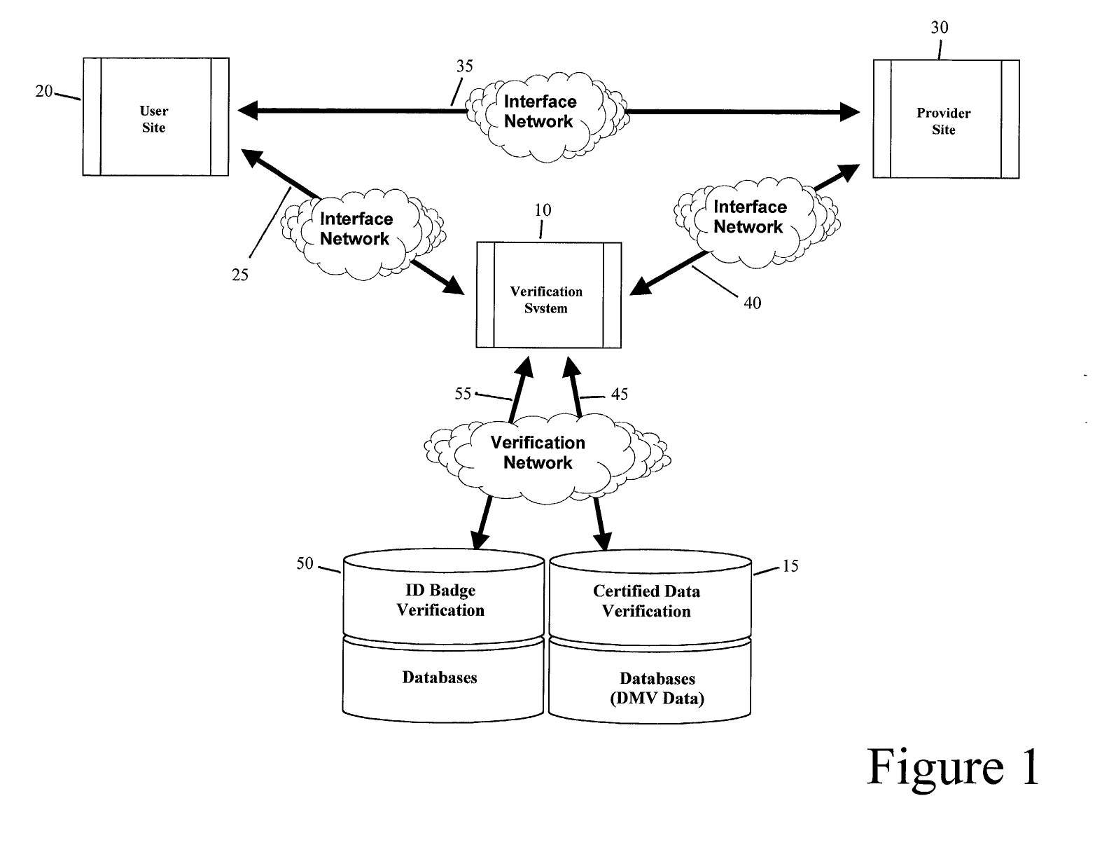

FIG. 1 is a part-schematic/part-flow diagram overview of the identity verification and authorization system of the present invention. The verification system 10 utilizes a verification database 15 built from certified data such as government, bank, notary, insurance or other certified data sources. Sources of certified data can be combined and cross-referenced with user-submitted data in order to create the database of the verification system of the present invention. In the present embodiment of the invention, driver's license data 15 (DMV data) is used. A user from a user site 20 may register at the verification system 10 site or by proxy at an on-line provider site 30, or physical “brick and mortar” establishment. The user provides personal information such as name, address, driver's license number, and social security number to the verification system over link 25. Alternatively, the user provides his or her personal information to the verification system by proxy at the provider site 30, over link 35, where the provider site securely routes the user's personal information to the verification system 10 over link 40. The verification system 10 cross-references the user-supplied data with the certified data over link 45, in the database 15 and, if it is valid information, creates for the user, a unique identifier and identification badge (ID badge), stores the user's unique identifier and ID badge over link 55 in the ID badge verification database 50, and returns ID badge access and usage instructions to the user. The user's ID badge that is stored in the ID badge verification database 50 contains, in encrypted format, the user's personal information (e.g. name, address and age) necessary for a provider 30 to authorize and complete a user requested transaction.

When the user wants to initiate an e-transaction from an on-line provider 30, the user submits from the user site 20 his or her unique identifier to the provider site 30 over link 35. Alternatively, if the user is not already registered with verification system 10, the user could register with the verification system by proxy in this transaction over link 35 prior to the verification of unique identification, which would proceed in a similar fashion to the user registration by proxy describe above. The provider 30, in response to the user's request, transmits the user's submitted unique identifier data to the verification system 10 over link 40, and requests verification of the user's unique identifier from the verification system 10. The verification system 10 then cross-references the submitted unique identifier with the unique identifier for the user stored in the ID badge verification database 50 over link 55 to confirm the user's identity. The verification system 10 confirms the user's identity by returning a record, which may be the digital ID badge containing only the subset of the user's personal information required by the provider to complete the requested transaction, to the provider 30 over link 40. The provider 30 can then decrypt the ID badge to reveal the user's personal information required by the provider 30 thereby authorizing the user to be eligible to complete the requested e-transaction.

In operation, the verification system 10 may provide a registration form by which the user over link 25 provides identification information such as name, address, driver's license number, date of birth, and Social Security number. The user “clicks” to authorize the verification system to use this information to verify his or her identity, which would either enable the process to create an ID badge for the user in the case of successful verification or reject the user in the case of unsuccessful verification.

When a user is ready to purchase items from a provider over the Internet, information is transferred to the verification system from the provider site via a secure link such as SSL, or other secure medium. The verification system decrypts the data and cross-references the information and sends back an encrypted authentication packet to the provider. The encrypted packet confirms the information gathered at the provider site. The provider then approves the transaction or cancels it based on the authorization data received from the verification system.

Referring again to FIG. 1, the link 40 between the verification system 10 and the provider site 30 is a secure transaction performed over a secure link such as a transaction protected by one of many available forms of encryption, such as SSL. SSL is commonly used for client/server applications on the Internet and operates by using a private key to encrypt data to be transferred over an SSL connection. Any other form of secure link that protects the exchange of the user's unique identifier and the verification system's authorization packet (by assuring message integrity and authenticating the source of the message) may be used within the scope of the present invention. The transactions between the user site 20 and the verification system 10 and between the user site 20 and the on-line provider site 30 are also secure transactions.

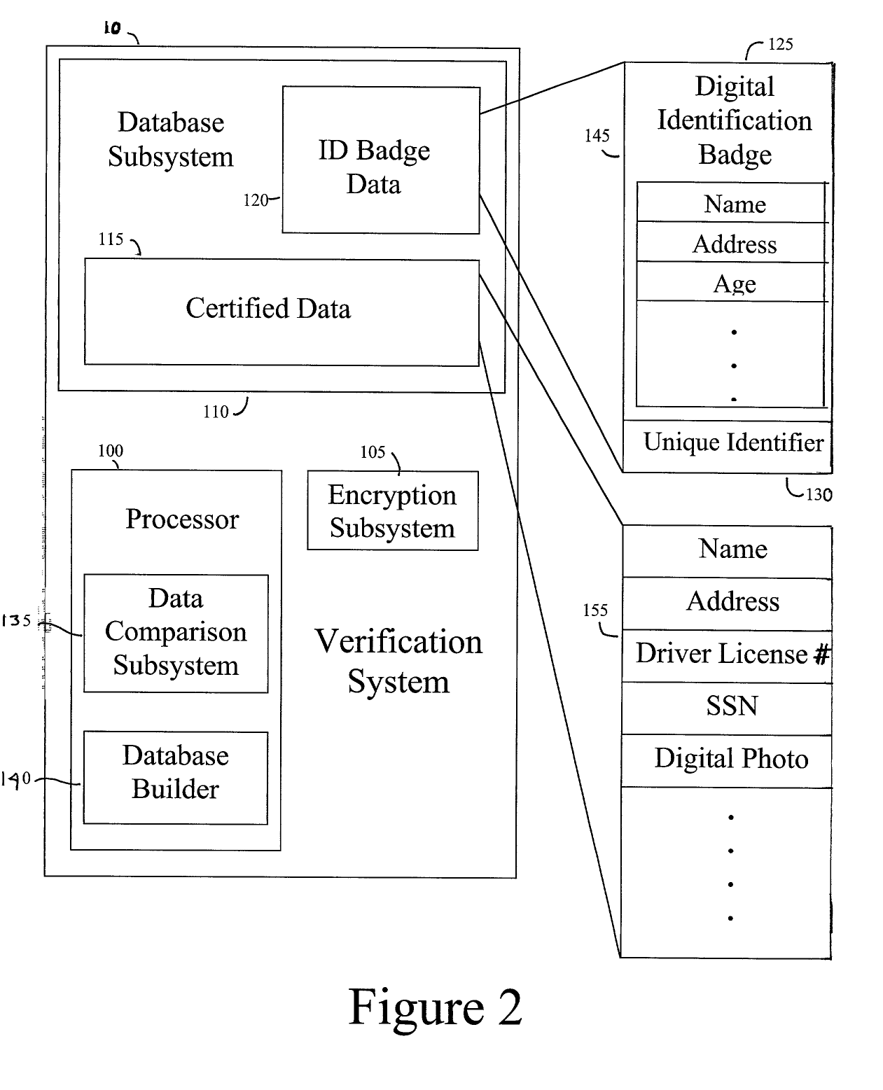

FIG. 2 is a block diagram of the verification system 10. The verification system 10 has a processor 100, an encryption subsystem 105, and a database subsystem 110. The processor 100 has a data comparison subsystem 135 and a database builder 140. The database subsystem 110 stores certified (e.g. government) data 115 and ID badge data 120.

In the present embodiment of the invention, the certified data 115 in the database subsystem 110 is driver's license data, however it may be any type of certified personal data that could be used to verify the identity of an individual. The certified data 115 in the database subsystem 110 holds records, such as the exemplary record 155 shown in FIG. 2, of personal data about a user such as name, address, driver's license number, Social Security number, digital photograph etc. The ID badge data 120 in the database subsystem 110 holds records, such as the exemplary record 125 shown in FIG. 2, of a unique identifier 130 and a digital identification badge 145 created by the verification system 10 from the user's personal data stored in record 155. The data comparison subsystem 135 cross-references data received from a user requesting registration, either directly from the user or by proxy from a provider during the course of an e-transaction, with the user's certified data record 155 to verify identification of the user. The database builder 140 creates the record entries in the record 125 including the unique identifierl30 and the digital identification badge 145, containing the user's personal data from the user's record 155, in the ID badge data database 120.

The verification processor 100 operates the verification system managing applications within the verification system 10 and communications from the Internet, to which the verification system 10 is attached. The encryption subsystem 105 is any type of encryption method used to provide secure network transmissions such as a single encryption type such as SSL. A combination of encryption methods could also be used within the scope of the present invention.

The system operates as follows. A user wanting to obtain an ID badge may register directly at the verification system site, by proxy through an on-line provider at the time of purchasing an item through the provider's site, or by any non-Internet means (e.g. by telephone, in person at a physical establishment). As described above, the verification system has a database created from certified datasets. The source of certified data may be, for example, driver's license data of one or more states and the District of Columbia, banks, insurance companies, notaries, or any other government or non-government institution.

During registration with the verification system, the user provides personal information, to establish identity. The verification system checks the verification database to cross-reference the user-provided information with the certified data in the verification database. The verification system then creates a unique identifier (e.g. a Personal Identification Number (PIN)) for the user, and creates digital identification badge (ID Badge) that contains the user's information necessary to complete an electronic transaction (e.g. digital signature, name, address, and, age), and stores the user's unique identifier and ID badge in the ID badge verification database. When the user wants to initiate a transaction with an on-line provider, the user transmits his or her unique identifier to the provider. The provider then similarly transmits this data to the verification system at the time of a transaction, which the verification system then uses to confirm the user's identity. Upon successful user identification verification, the verification system transfers the user's ID badge to the provider as proof of authorization to complete the user's requested transaction. If the user is not successfully verified, the provider is notified of the unauthorized status of the user, allowing the provider to make a decision as to whether or not the transaction requested by the user is to be completed.

The digital identification badge is transmitted in an incorruptible information packet, which, with the user's authorization (e.g. use of PIN, sliding of cryptocard, etc.), is sent to the provider over the Internet. The ID badge transferred is incorruptible because it is transmitted directly from the verification system's site to the provider site in encrypted form using, for example, Public Key Infrastructure (PKI) or Secure Sockets Layer (SSL) encryption.

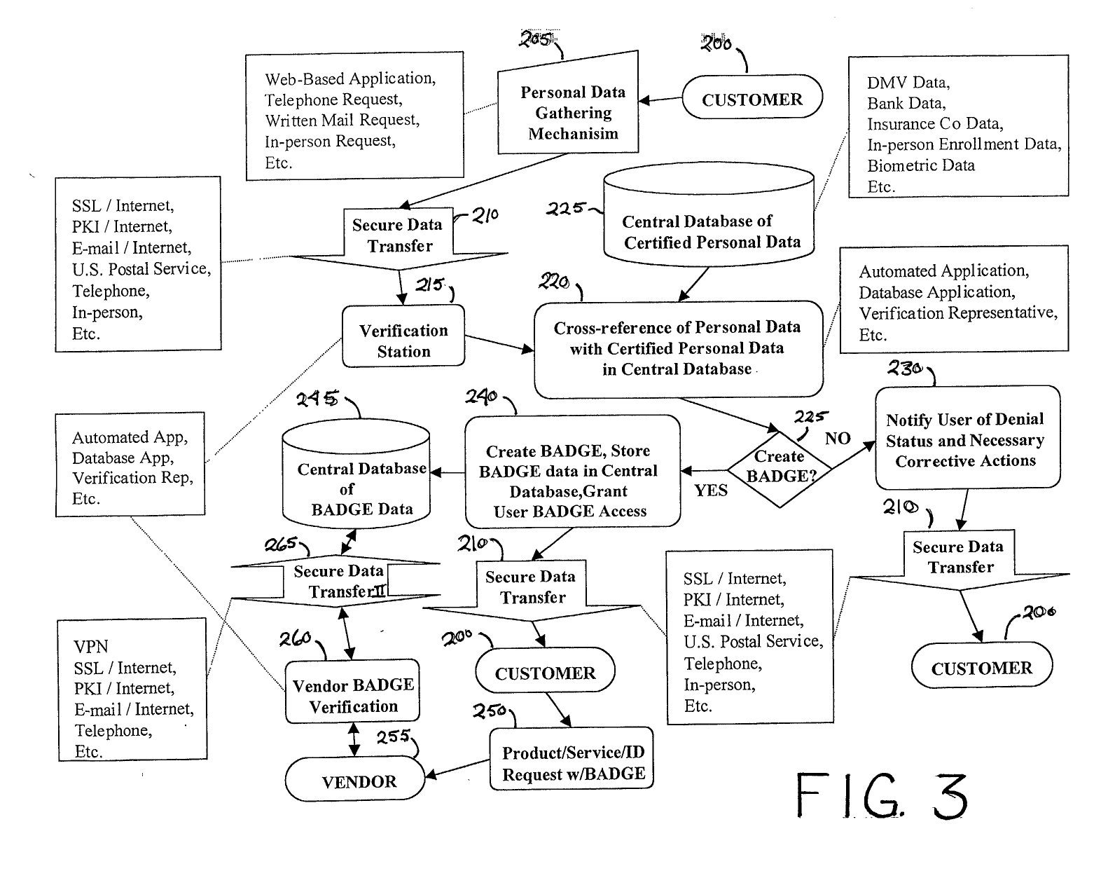

FIG. 3 is a detailed part-schematic block diagram/part-flow chart of the verification process of the present invention. A first party, typically a customer 200, uses one of several personal data-gathering mechanisms to supply personal data to a receiver, block 205. These personal data-gathering mechanisms include but are not limited to a web-based application, a telephone request, a written request delivered by the U.S. Postal Service, and an in-person request. The receiver then performs a secure data transfer, block 210, to a verification station 215. The secure data transfer may be performed as encrypted transactions over the Internet using, for example, SSL or PKI, by telephone, or in person or any other means of data transfer that provides an acceptable level of assurance that the information is being sent by an authorized requester (including ordinary e-mail or mail with other safeguards).

The verification station 215 is connected to central database 225 of certified personal data such as driver's license data, bank data, insurance company data, in-person enrollment data, biometric data, notarized data, etc. The verification station 215 cross-references the personal data supplied by the customer 200 with the certified data in the central database, block 220. The cross-reference operation may be performed by an automated application, a database application, a verification representative or any other means of accomplishing this task.

The verification station 215 then makes the decision whether or not to provide a unique identifier based on the outcome of the cross-reference operation, block 225. If the data does not cross-reference properly, notification to the user is prepared including the denied status and the necessary corrective actions, block 230. This notification is transferred to the customer 200 by secure data transfer 210.

If the data cross-references properly, a unique identifier (or Personal Identification Number (PIN)) and an encrypted digital identification badge, also called an electronic user badge, containing information crucial to a transaction (e.g. name, address, and age) is created and stored, block 240, in a central database of electronic badges, block 245. The central database of electronic badges 245 and the central database of certified personal data 225 may be combined as one database or maintained as separate databases. The unique identifier is also transferred to the customer 200 by secure data transfer 210.

To order a product from a vendor 255, the customer 200 includes the unique identifier with the product request, block 250. The vendor 255 prepares a badge verification request 260 which is transmitted to the central badge database 245 by a second type of secure data transfer which includes virtual private network (VPN), SSL, PKI, e-mail, U.S. Postal Service, by telephone, in person transfer or some other means of secure data transfer. A verification of the badge is sent back to the vendor 260 by means of an automated application, a database application, a verification representative or some other means, block 265. When the badge is verified, the vendor is assured that the customer is qualified for the transaction and proceeds with the transaction with the customer.

Additional safeguards to prevent the transfer of a badge to a minor, for example, may be to cross-reference against other personal information (which may be a delivery address) either at the verification center or at the vendor site.

In alternative embodiments, the authentication system may also be used for vending machines and kiosks with a distribution of cryptocards (i.e. smartcards) that are ordered by authenticated individuals. In further alternative embodiments, the verification system would include biometrics in order to confirm the identity of the person.

It is to be understood that the above-described embodiments are simply illustrative of the principles of the invention. Various and other modifications and changes may be made by those skilled in the art, which will embody the principles of the invention and fall within the spirit and scope thereof.

What is claimed is:

1. A method for personal identification and authentication, comprising the steps of:
a) creating a first central database of certified personal information;
b) creating a second central database to store digital identification badge data;
c) collecting over the Internet user personal information from a user requesting a digital identification badge;
d) transferring said user personal information to a verification station over the Internet using a secure transmission protocol;
e) cross-referencing said user personal information with said certified personal information to certify, deny, or determine inconclusive evidence for creating a digital identification badge;
f) if a digital identification badge is not certified in step e),
i) storing said user personal information in said second central database;
ii) notifying said user of badge status with instructions for corrective action;
g) if a digital identification badge is certified in step e),
i) creating a digital identification badge;
ii) storing personal information in said digital identification badge;
iii) storing said digital identification badge in said second central database;
iv) providing over the Internet using said secure transmission protocol, access to said encrypted digital identification badge to said user for use in facilitating transactions and purchases over the Internet.

2. The method of claim 1 wherein said certified personal information further comprises government data.

3. The method of claim 1 wherein said certified personal information further comprises data from a non-government institution.

4. The method of claim 3 wherein said non-government institution is a bank.

5. The method of claim 3 wherein said non-government institution is an insurance company.

6. The method of claim 3 wherein said non-government institution is a credit bureau.

7. The method of claim 1 wherein said user personal information further comprises biometric data.

8. The method of claim 1 wherein said collecting step further comprises collecting said user personal information from a user.

9. The method of claim 8 wherein said collecting step further comprises collecting said user personal information from a user through an on-line vendor.

10. A personal authentication/identification method for creating a digital identification badge, comprising the steps of:
a) providing a central information database of certified personal information;
b) creating a central badge database for the storing personal information of users and incorruptible digital identification badges;
c) receiving a request for a digital identification badge from a user, said request containing personal information from said user;
d) encrypting said request for a digital identification badge;
e) transferring said encrypted request to a verification site;
f) checking said personal information in said request with said certified personal information to determine whether said user is eligible for a digital identification badge;
g) storing said personal information in said central badge database;
h) if said user is eligible for a digital identification badge,
i) creating a digital identification badge for said user;
ii) storing said digital identification badge for said user;
iii) encrypting certified personal information in said digital identification badge; and,
iv) providing over the Internet access to said encrypted digital identification badge to said user for use in facilitating transactions and purchases over the Internet.

11. The method of claim 10 wherein step a) further comprises providing a central certified information database of government data.

12. The method of claim 10 wherein step a) further comprises providing a central certified information database of data from a non-government institution.

13. The method of claim 12 wherein said non-government institution is a bank.

14. The method of claim 12 wherein said non-government institution is an insurance company.

15. A method of buyer identity verification for e-commerce, comprising the steps of:
a) providing a database of certified personal data;
b) receiving buyer-submitted personal data and a request for a unique identification from a buyer;
c) validating said buyer-submitted personal data with said certified personal data;
d) if said buyer-submitted personal data validates,
i) creating a unique identification for said buyer; and
ii) storing said unique identification in anticipation of confirming said unique identification to vendors servicing said buyer.

16. A process for verification of the identity of a first party in an electronic transaction with a second party, said process comprising the steps of:
a) submitting by said first party to said second party a non-governmental third party certificate of said identity, said certificate including personal information of said first party and certified information provided by said third party; and subsequently
b) comparing by said second party or its proxy said personal information to personal information provided by said first party as a component of said transaction; and
c) comparing by said second party or its proxy of said certificate information to information provided by said third party for said first party;
said steps performed during substantially a single session of communication.

17. The process of claim 16 wherein the personal information provided by said first party as a component of said transaction is personal information related to said transaction.

18. The process of claim 16 wherein said information provided by said third party for comparison in step (c) to said certificate information is provided subsequent to step (a).

19. The process of claim 16 wherein step (c) is performed by said third party as a proxy for said second party.

20. The process of claim 16 wherein said personal information is biometric data.

21. The process of claim 16 wherein said electronic transaction is an e-commerce transaction and further comprising the steps of:
receiving by said second party an order from said first party for an item; and
providing by said second party said item to said first party in response to said order and said certificate of identity.

22. The process of claim 16 wherein said electronic transaction is an e-pharmacy transaction and further comprising the steps of:
receiving by said second party a prescription for said first party; and
providing by second party a prescription item to said first party in response to said prescription and said certificate of identity.

23. The process of claim 16 wherein said electronic transaction is an e-government transaction and further comprising the steps of:
receiving by said second party a vote from said first party; and
authenticating said vote in response to said certificate of identity.

24. A system for identity verification of a first party by a second party in a transaction, comprising:
a) means for submitting by the first party to the second party an identity certificate having personal information of the first party and certified information provided by a third party;
b) personal information comparing means for comparing by said second party said identity certificate personal information to personal information provided by the first party; and
c) certificate information comparing means for comparing by said second party said identity certificate third party information to information provided by the third party for the first party,
whereby verification of said identity certificate personal information and said identity certificate certified information verifies to said second party the identity of the first party.

25. The system of claim 24 wherein the personal information provided by the first party is personal information related to the transaction.

26. The system of claim 24 wherein said means for submitting further comprises a secure network link transmission.

27. The system of claim 24 wherein said secure network link transmission further comprises Secure Lockets Layer communication.

28. The system of claim 24 wherein said secure network link transmission further comprises a public key encryption scheme transmission.

29. The system of claim 24 wherein said personal information provided by the first party is biometric data.

30. A system for personal identity verification, comprising:
a first secure link between a vendor and a customer to be used by said customer for transmitting personal information to said vendor;
a verification system having a database of certified personal information;
a second secure link between said vendor and said verification system;
a database builder having links to at least one source of certified personal information, said database builder providing periodic updates to said database of certified personal information; and
a data comparison subsystem for comparing said customer personal information with said certified personal information,
said verification system issuing a customer badge if said customer personal information is verified.

31. The system of claim 30 wherein said at least one source of certified personal information comprises a government agency.

32. The system of claim 30 wherein said government agency is a Department of Motor Vehicles.

33. The system of claim 30 wherein said at least one source of certified personal information comprises a non-government agency.

34. The system of claim 33 wherein said non-government agency is an insurance company.

35. The system of claim 33 wherein said non-government agency is a bank.

36. A verification system for verifying identity (of which age is a subset of) of persons for Internet-commerce, comprising:
a secure link for use by vendors and customers for transmitting customer personal information to the verification system;
a database of certified personal information;
a verification processor for comparing customer personal information transmitted over said secure link with said certified personal information, said verification processor for generating a unique identifier in response to verification of said customer personal information; and
a database of storing said transmitted personal information and said unique identifier for use in authorizing Internet-commerce transactions by said customer.

37. A system for a vendor to verify identity of a customer, comprising:
means for receiving personal information from the customer;
means for establishing a secure link to a verification station;
means for forwarding said received personal information over said secure link;
means for receiving verification from said verification station in response to said received personal information,
whereby the vendor approves a transaction with the customer in response to receiving said verification.

38. The system of claim 37 wherein said verification further comprises a digital certificate to be forwarded by the vendor to the customer.

39. A verification system for identity verification comprising:
a first database of user data to store user personal information and associated unique identifiers and digital identification badges;
a second database to store certified data; and
a processor to build the first database by verifying user data with certified data and to created a unique identifier and a digital identification badge in response to verified user data.

40. The verification system of claim 39 further comprising:
an encryption subsystem for encrypting verification transmissions verifying the identity of a requester.
